(19) United States
(12) Patent Application Publication
(10) Pub. No.: US 2024/0296454 A1
(43) Pub. Date: Sep. 5, 2024

(54) EterCash Limited Business Description

(71) Applicants: Oluwole Victor Awoyemi, Hawthorn Woods, IL (US); Adeola Deborah Olubamiji, Hawthorn Woods, IL (US)

(72) Inventors: Oluwole Victor Awoyemi, Hawthorn Woods, IL (US); Adeola Deborah Olubamiji, Hawthorn Woods, IL (US)

(21) Appl. No.: 18/117,367

(22) Filed: Mar. 3, 2023

(51) Int. Cl. G06Q 20/40

(52) U.S. Cl. CPC G06Q 20/4016

(57) ABSTRACT

EterCash is a Person-to-Service-to-Person (PSSP) system that enables users to send and receive money using their mobile phone numbers and email addresses. The system is designed to provide a fast, secure, and convenient way to transfer funds between individuals or businesses within minutes. EterCash leverages the latest mobile and web-based technologies to provide a seamless experience for users. EterCash is a revolutionary payment service provider that allows users to send money to individuals or businesses in just a matter of minutes using a mobile phone number or email address. With its user-friendly interface and cutting-edge technology, EterCash aims to make financial transactions faster, more convenient, and more accessible to everyone, regardless of their location or background. Whether you need to pay for a product or service, send money to a friend or family member, or simply transfer funds between your own accounts, EterCash offers a secure and reliable platform that puts your needs first. The present invention relates to a secure payment system developed by EterCash, a pioneering payment service provider (PSP). The innovative payment system enables fast, convenient, and secure transactions using phone numbers and email addresses as unique identifiers for users. The system's core functionality is built upon a robust infrastructure, advanced encryption techniques, and multi-factor authentication mechanisms to ensure the highest level of security in digital financial transactions.

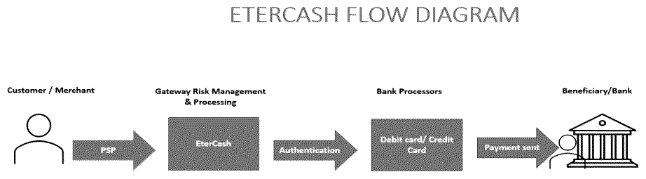

EterCash is a payment solution service provider that provides users with a secure and easy way to send and receive money. With EterCash, users can send and receive money both domestically and internationally, either digitally or via cash. EterCash also allows users to use services such as bills payment, rent payment, and many more. The platform is fast, reliable, and secure, and users can be sure of secure transactions as EterCash is compliant with international data protection regulations. With EterCash, users can enjoy the convenience of money transfer from the comfort of their homes.

EterCash is a computer-based service developed to facilitate the secure peer-to-peer transfer of funds from one person to another. It enables users to transact online quickly and easily in a secure and confidential manner, while avoiding the necessity of authorizing authorization of a third-party or issuer of a security deposit. The service will make use of current encryption standards and secure socket layer technologies to ensure its safety and confidentiality.

EterCash Payments provides a wide range of payment options for consumers, allowing them to pay with debit or with credit cards, hold funds in EterCash savings accounts, transfer funds between accounts, make withdrawals, request refunds, and make payments. The system also enables merchants to securely receive payments and helps to ensure the security and privacy of payments. EterCash Payments also helps to reduce fraud and ensures that payments are processed quickly and securely. In addition to providing flexibility and security, EterCash's advanced technology helps to reduce transaction costs and make international payments simpler.

EterCash is a revolutionary payment service provider that allows users to send money to individuals or businesses in just a matter of minutes using a mobile phone number or email address. With its user-friendly interface and cutting-edge technology, EterCash aims to make financial transactions faster, more convenient, and more accessible to everyone, regardless of their location or background. Whether you need to pay for a product or service, send money to a friend or family member, or simply transfer funds between your own accounts, EterCash offers a secure and reliable platform that puts your needs first. So why wait? Join the growing community of EterCash users today and experience a whole new level of financial freedom and flexibility.

EterCash is a Payment Service Provider (PSSP) that offers a convenient and fast way to send money to individuals or businesses via an app using either their phone number or email address. With EterCash, users can securely send money within minutes, making it an ideal solution for those who need to transfer funds quickly and efficiently. Not only is EterCash fast and secure, but it is also user-friendly, with an easy-to-use app that allows users to easily manage their payments and track their activity. Users can also connect their bank account, debit card or credit card to make transactions even easier. One of the key benefits of EterCash is its ability to send money to both individuals and businesses. This means users can quickly and easily pay their bills or buy products and services using the app.

Overall, EterCash is a reliable, efficient, and secure way to send money, making it an ideal solution for anyone looking for a fast and convenient way to manage their payments.
EterCash Account setup, bank account setup

Setting up a payment service provider account requires you to provide valid and up-to-date documents that are used to verify your identity and financial status. This includes your driver License or ID card, bank account details, email address, and phone number to complete the account setup. Once your documents are registered and accepted, you will be able to use your EterCash account to make purchases, accept payments, and transfer money as needed.

### DRAWING BRIEF DESCRIPTION

An EterCash user put in their details to make a payment on our application powered by EterCash. Users indicated the mode of payment using their debit cards or credit cards. EterCash will authenticate the card details ensuring that the user is trying to make a payment. EterCash reaches out to our bank partner to collect the input amount from users' bank.

EterCash ensures the issued card information is correct and asks the bank for the amount inputted by the user to make transfer/payment. The payment is made within second and it is debited from the user account and credited to the account being paid to using either phone number or email address.

### EXAMPLE

Request: User A input your details to make a 1,000 Naira payment.

Response and Action: EterCash will debit 1,000 Naira from my bank account and credit ABC Inc. with the same amount.

### EterCash Flow

EterCash will offer a variety of features including:
1. Secure payment options: EterCash's payment system will allow users to conduct transactions using secure payment processing services easily. This feature will enable users to make payments with complete privacy and security, removing the need for the user to authorize a third-party to process their transaction.
2. Discreet account transfers: EterCash will enable users to discreetly transfer funds from their accounts without requiring any authorization from a financial institution. This feature will provide users with an additional layer of privacy and protection when conducting financial transactions.
3. Full integration with traditional banking: EterCash will be fully integrated with traditional banking systems and give users the option of transferring funds directly to and from their banks. This feature will enable users to take full advantage of their banking accounts while still enjoying the privacy and discretion that EterCash provides.
4. International transfers: EterCash will also offer users the ability to transfer funds internationally securely and discreetly. This feature will provide users with the ability to wire funds quickly and securely across borders, removing the need to rely on third parties or authorization forms.

1. This application claims the benefit of priority of Provisional Patent Application Ser. No. 18/117,367 by same inventors that was filed Mar. 3, 2023. The described payment solution service system provides users with a secure and easy way to send and receive money, where users can initiate money transfer requests using recipient phone numbers or email addresses as transaction identifiers, and recipients can confirm or authorize incoming money transfers using their registered account identifiers, which are associated with their respective user accounts. The system ensures data security through encryption of sensitive user data associated with money transfer transactions and facilitates communication with external payment networks for seamless fund transfers between users and accounts. Furthermore, the system maintains a transaction history database for accurate tracking and recording of transaction details, enhancing user transparency and control over their financial activities. The EterCash payment system addresses several challenges faced by users in traditional payment methods, such as the need for complex bank details and cumbersome transaction processes. By leveraging phone numbers and email addresses as payment identifiers, EterCash streamlines the transaction experience, making it accessible to a broader demographic, including the unbanked and underbanked populations.
Key Components of the EterCash Payment System:
1. User Identification and Registration: The EterCash payment system provides users with the option to register and create a secure account using their phone numbers or email addresses as unique identifiers. During the registration process, users' identity is verified through a series of authentication steps, ensuring the accuracy and legitimacy of user data.
2. Multi-Factor Authentication: To enhance the security of the payment system, EterCash implements multi-factor authentication (MFA) techniques. This requires users to provide additional verification factors, such as biometric data or one-time passwords (OTPs) sent to their registered phone numbers or email addresses, before completing sensitive transactions.
3. Secure Communication Protocol: EterCash employs a secure communication protocol for all data transmissions between users and the platform. Industry-standard encryption algorithms ensure the confidentiality and integrity of user data, preventing unauthorized access and data breaches.
4. Payment Processing and Settlement: The EterCash payment system utilizes an efficient payment processing mechanism to facilitate seamless fund transfers between users. Payments are processed in real-time, ensuring instant transaction settlements, reducing the waiting time associated with traditional banking systems.
5. User-Friendly Interface: EterCash boasts a user-friendly interface that enhances the user experience and promotes ease of use. The intuitive design allows users to navigate the platform effortlessly, facilitating swift and hassle-free transactions.
6. Fraud Detection and Prevention: The payment system incorporates advanced fraud detection and prevention measures to identify and mitigate potential security threats. Machine learning algorithms analyze transaction patterns and user behavior to detect anomalies, enabling the platform to respond proactively to suspicious activities.
7. Financial Inclusion and Accessibility: By using phone numbers and email addresses as identifiers, EterCash aims to promote financial inclusion and accessibility for the unbanked and underbanked populations. The system bridges the gap between traditional banking services and digital payments, empowering individuals from diverse economic backgrounds to participate in the digital economy.
Conclusion: The secure payment system developed by EterCash represents a groundbreaking advancement in digital financial transactions. By leveraging phone numbers and email addresses as unique identifiers, EterCash offers a convenient and secure payment solution for users, promoting financial inclusion and accessibility. The system's robust infrastructure, multi-factor authentication, and fraud prevention measures ensure the highest level of security for users, establishing EterCash as a pioneering payment service provider in the digital payment landscape in the United States. EterCash's payment system, utilizing mobile phone numbers and email addresses for transactions, exemplifies a transformative advancement in United States digital payment industry. By prioritizing user convenience, financial inclusion, and robust security, EterCash has emerged as a trusted PSSP, empowering individuals and businesses to navigate the digital economy with ease and confidence. Through its innovative approach and commitment to user-centric services, EterCash continues to redefine the payment landscape in the United States, driving financial progress and fostering economic empowerments for all.
